(19) United States
(12) Patent Application Publication
(10) Pub. No.: US 2006/0249604 A1
(43) Pub. Date: Nov. 9, 2006

(54) Fuel injector seat and director plate assembly

(76) Inventors: Paul S. Von Bacho III, Rochester, NY (US); Julie M. Galante-Fox, Hemlock, NY (US); Eugene A. Kobos, Henrietta, NY (US); David W. Sant, Fairport, NY (US); Renae N. Veneziano, West Henrietta, NY (US); Michael Schneider, Victor, NY (US); Sudhakar Das, Rochester, NY (US)

Correspondence Address: DELPHI TECHNOLOGIES, INC., M/C 480-410-202, PO BOX 5052, TROY, MI, 48007, US

(21) Appl. No.: 11/111,115

(22) Filed: Apr. 21, 2005

(51) Int. Cl. B05B 1/30

(52) U.S. Cl. 239/900; 239/585.4; 239/596; 239/552; 239/494

(57) ABSTRACT

A fuel injection valve and director plate assembly including a circular beveled valve seat, a valve ball for forming a circular sealing line against the seat, and a perforated director plate. The improved valve seat is substantially thicker than a prior art seat to provide greater mass of seat material and hence reduced vulnerability of the seat to thermal distortion from welding. To obviate an increase in residual fuel volume that would result from displacing the director plate from the valve by the added thickness of the seat, the central portion of an improved director plate is made concave such that the actual fuel-directing portion of the director plate is to the valve ball in the prior art relationship, thus preserving the desirably small prior art volume of residual fuel after valve closing.

### TECHNICAL FIELD

The present invention relates to fuel injectors for internal combustion engines; more particularly, to fuel injectors for direct injection of fuel into the cylinders of such engines; and most particularly, to an improved seat and director plate assembly for a fuel injector wherein a fuel volume of fuel accumulated past the seat is reduced.

### BACKGROUND OF THE INVENTION

Fuel injected internal combustion engines are well known. In direct-injected engines, the injection tip of the fuel injector extends into the combustion chamber and includes a perforated plate, known in the art as a “director plate,” for dispersing and directing fuel injected from the injection valve. In a conventional engine fuel injection system, the injection tip of the injector extends into a plenum or rail of the engine's intake manifold where the injected fuel is mixed with intake air before being discharged into the engine's combustion chamber.

As is well known in a direct injected engine, the configuration and positioning of a director plate with respect to the injection valve and the top of an engine piston are critical elements in the most fuel-efficient distribution of fuel into the firing chamber. A typical fuel injection valve includes a beveled circular seat and a reciprocably-actuated ball that seals against the seat in a circular sealing line.

A known problem in prior art fuel injectors is that the volume of fuel remaining between the valve ball and the director plate can be oxidized and polymerized by residual heat when an engine is shut down, leading to unwanted deposits on the valve and director plate. Further, any residual fuel outside the valve after each injection event must be displaced by the next succeeding injection event. A relatively large fuel residue can adversely affect the injection spray pattern and atomization intended by the director plate. Therefore, in prior art fuel injectors the valve seat typically is relatively thin below the sealing line to permit the director plate, which is co-planar with the axial end of the seat in this region of the plate, to approach the ball, thus minimizing the residual volume of fuel. However, experience has shown that a thin valve seat is vulnerable to mechanical deformation from the seat being inserted into the injector and to thermal deformation from welding of the seat in place during manufacture thereof, thus spoiling the uniformity of a circular sealing line and permitting additional fuel to leak past the valve ball during shutdown.

What is needed in the art is a fuel injector having a thicker seat that will not deform during welding, but at no increase in residual fuel volume.

It is a principal object of the present invention to reduce fuel leakage past a fuel injection valve during shutdown, without increasing the volume of residual fuel between the injection valve and the director plate.

### SUMMARY OF THE INVENTION

Briefly described, an improved fuel injection valve and director plate assembly in accordance with the invention includes an annular beveled valve seat, a valve ball for forming a circular sealing line against the seat, and a perforated director plate. With reference to the thickness of a prior art seat at the radius of the sealing line, the improved seat is substantially thickened in an axial direction to provide greater mass of seat material and hence reduced vulnerability of the seat to thermal distortion from welding. Thus, a circular sealing line is assured after welding of the seat into the fuel injector assembly. To obviate an increase in residual fuel volume that would result from displacing the director plate from the valve by the added thickness of the seat, the central portion of an improved director plate is made concave from the outer portion such that the actual fuel-directing portion of the director plate is spaced from the valve ball as in the prior art relationship, thus preserving the desirably small prior art volume of residual fuel after valve closing.

### BRIEF DESCRIPTION OF THE DRAWINGS

The present invention will now be described, by way of example, with reference to the accompanying drawings, in which:

FIG. 1 is an elevational cross-sectional view of a prior art fuel injection valve assembly including a valve seat, a valve ball, and a director plate; and

FIG. 2 is an elevational cross-sectional view of a fuel injection valve assembly in accordance with the invention.

### DESCRIPTION OF THE PREFERRED EMBODIMENTS

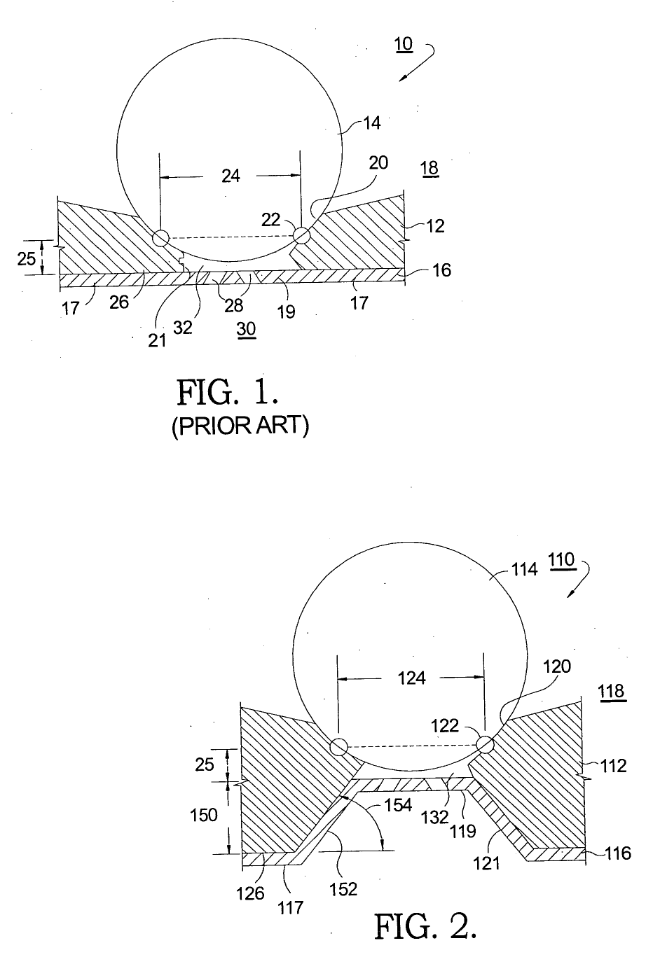

Referring to FIG. 1, a prior art fuel injection valve and director plate assembly 10 comprises a valve seat 12, a valve ball 14, and a director plate 16. As is well known in the prior art and need not be shown here, valve seat 12 is adapted to be sealingly welded into a body (not shown) of a fuel injector 18. Seat 12 is provided with an annular first conically beveled face 20 for receiving valve ball 14 in a circular sealing line 22 having a diameter 24 greater than the diameter of the injection opening in seat 12. First beveled face 20 typically terminates in a second beveled face 21 reverse-beveled from face 20 defining a conical exit opening to permit dispersal of fuel injected by the valve. Controllably varying the position of valve ball 14 with respect to face 20 25 controllably varies the flow of fuel across seat 12. Prior art director plate 16 is coplanar with axial face 26 of seat 12 over both a peripheral portion 17 and a central portion 19 of plate 16. Central portion 19 is provided with a plurality of distribution holes 28 for discharging into a firing chamber 30 fuel having passed across seat 12. (Of course, director plate 16 typically is configured non-planarly in any of various ways outside of the region shown in FIG. 1 in order to be inserted and attached within the fuel injector body.)

When valve ball 14 is sealed against face 20, a space 32 is formed among the seat, the ball, and the director plate. The volume of this space is known in the art as the SAC volume of a fuel injector. As noted above, it is desirable to minimize the SAC volume 32. In the prior art, this is achieved by minimizing the axial thickness of seat 12 to nearly the point at which director plate 16 interferes with ball 14. As noted above, a relatively thin seat as shown in FIG. 1 may be distorted by the process of inserting or welding the seat into the fuel injector body during manufacture of a fuel injector. Such distortion can affect the conicity of bevel face 20, thereby preventing ball 14 from forming a continuous sealing line 22 and causing the valve to leak.

Referring to FIG. 2, an improved fuel injection valve and director plate assembly 110 in accordance with the invention comprises a valve seat 112, a valve ball 114, and a director plate 116. Valve ball 114 is substantially identical with prior art valve ball 14, and first conical bevel face 120 and circular sealing line 122 are also substantially identical with their prior art counterparts.

Novel assembly 110 differs from prior art assembly 10 in the following ways.

Valve seat 112 is thicker than seat 12 by an amount 150 which preferably is at least about twice the thickness 25 of prior art seat 12 or more between sealing line 22 and axial face 26. Thickening the valve seat in this fashion increases the mass of the valve seat and thereby prevents the valve seat from being thermally deformed by welding during assembly of improved fuel injector 118. Further, thickening of the valve seat creates a second beveled face 121 defining a conical exit opening significantly longer along the cone surface than prior art face 21. Improved seat 112 terminates at an axial face 126.

An immediately-obvious disadvantage of improved seat 112 is that the greater thickness 150 and longer length of face 121 creates a potentially much larger SAC volume for fuel injector 118. To obviate this effect and provide a SAC volume 132 equal to SAC volume 32, the preferably-planar central portion 119 of improved director plate 116 is axially displaced from the preferably-planar peripheral portion 117 by a distance equal to increased thickness 150. Preferably, a transition portion 152 is formed at an angle 154 from surface 126 which is equal to the cone angle of face 121. Thus, the central portion 119 is spaced from ball 114 identically with the spacing of portion 19 from ball 14, and therefore SAC volume 132 may be made the same as SAC volume 32. Of course, the SAC volume of improved fuel injector 118 may be varied as may be desired by varying the distance that central portion 119 is displaced from peripheral portion 117.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel injection valve and director plate assembly, comprising:
a) a valve seat;
b) a valve ball for forming a circular sealing line against said valve seat; and
c) a perforated director plate disposed against an axial face of said valve seat, wherein said director plate includes a peripheral portion coplanar with said axial face of said valve seat and a central portion axially displaced from said peripheral portion in the direction of said valve ball.

2. An assembly in accordance with claim 1 wherein said valve seat includes a conical exit opening forming a first angle with said axial surface of said valve seat, and wherein said director plate includes a transition portion between said peripheral portion and said central portion, and wherein said transition portion forms a second angle with said peripheral portion identical to said first angle.

3. A director plate for a fuel injection assembly comprising a planar peripheral portion and a planar central portion, wherein said central portion is axially displaced from said peripheral portion.

4. A fuel injector comprising a fuel injection valve and director plate assembly having
a valve seat,
a valve ball for forming a circular sealing line against said valve seat, and
a perforated director plate disposed against an axial face of said valve seat,
wherein said director plate includes a peripheral portion coplanar with said axial face of said valve seat and a central portion axially displaced from said peripheral portion in the direction of said valve ball.
